(19) United States
(12) Patent Application Publication
(10) Pub. No.: US 2007/0020505 A1
(43) Pub. Date: Jan. 25, 2007

(54) Electrochemical arrangement comprising an elastic distribution structure

(76) Inventors: Dieter Grafl, Ulm (DE); Raimund Strobel, Ulm (DE); Markus Lemm, Blaustein (DE); Kai Lemke, Ulm (DE); Dominique Tasch, Mietingen (DE); Bernd Gaugler, Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/561,088

(22) PCT Filed: Jun. 18, 2004
(86) PCT No.: PCT/EP04/06670

§ 371 Date: May 5, 2006

(30) Foreign Application Priority Data
Jun. 18, 2003 (DE) 103 28 039.1

(51) Int. Cl. H01M 8/02; C25B 9/00

(52) U.S. Cl. 429/38; 204/278

(57) ABSTRACT

An electrochemical arrangement with at least one distribution structure for introducing and distributing a reactant, which is designed as a composite of several layers, and wherein the distribution structure is led essentially in a plane and is elastic against pressure loading perpendicular to the plane in a controlled manner.

The invention relates to an electrochemical arrangement such as a fuel cell arrangement, an electrolyser or an electrochemical compressor, according to the features of the preamble of patent claim 1.

For electrochemical arrangements of the previously mentioned type, it is necessary to lead fluids such a reactants or coolants into the inside of the arrangement. In the following, the invention is represented by way of a prominent example of a fuel cell arrangement, which is to represent such electrochemical arrangements.

A fuel cell arrangement in the context of this patent application typically contains a first and a second bipolar plate between which the actual fuel cell, commonly in the form of an MEA (membrane electrode assembly), is arranged.

In order to distribute the reactants required for the operation of the fuel cell uniformly along the surface of the fuel cell or MEA, one often applies distribution structures which are designed as channels. Furthermore, channel-like structures or partial stampings may be applied as distribution structures, which may serve for the introduction and the homogeneous distribution of reactants or of the cooling medium. These are often incorporated into the fuel cell bipolar plate.

One basic disadvantage of the fuel cell systems which consists essentially of arrangements of bipolar plates, MEA, as well as possibly further layers, as a layering, is the fact that already even with a small deviation of the dimensions of these layer components, one may not reliably ensure an adequate contact and pressing pressure from layer component to layer component.

If one or more such layer fuel cell arrangements are held together by way of clamping elements, then the force of the pressing pressure is mostly introduced in a pointwise manner into each of the two-dimensional arrangements, which has the result that a non-uniform force distribution systematically arises in the region of the active surface of the respective arrangements.

The disadvantages effect which arises due to this manifests itself in particular in an increased electrical internal resistance of the fuel cell, and a significant reduction in the power.

This disadvantage becomes particularly grave in combination with the sealing concept of fuel cells known from the state of the art; thereby, the sealing is applied into the main force closure or auxiliary force closure, so that seal tolerances inherent to the manufacturing process cause an inhomogeneous and partly insufficient pressing or inadequate sealing of the active surfaces in one or in several fuel cell arrangements which are constructed in layers, since the bracing forces between the sealing elements and the active cell functional regions are distributed in an inadequately precise manner.

It is the object of the present invention to provide an electrochemical arrangement such as a fuel cell arrangement, an electrolyser or an electrochemical compressor with at least one distribution structure for introducing and distributing a reactant, which avoids the mentioned disadvantages of the state of the art, and in particular due to the reliable provision of an adequate and homogeneously distributed pressing pressure, ensures a high flow of current without significant losses.

According to the invention, this object is achieved by an electrochemical arrangement according to patent claim 1.

The solution according to the invention thereby in particular has the following advantages:

By way the distribution structure being led essentially in a plane and being elastic in a controlled manner counter to a pressure loading perpendicular to this plane, one achieves a design solution for creating adequate and homogeneously distributed pressing forces from layer component to layer component within the active surfaces of an electrochemical arrangement, such as a fuel cell arrangement, an electrolyser or an electrochemical compressor, wherein this solution technically is particularly robust, is universal and requires little expense.

By way of the fact that the elasticity of the distribution structure is realised in a partially controlled manner or the distribution structure is deliberately provided with a certain elasticity, the technical effect which is described here may be applied in practise in an advantageous and targeted manner.

Thereby, the distribution structure is formed by spring-elastic boundary walls for the leading of the fluids.

If the layer elements are joined together into an electrochemical arrangement, then the spring-elastic distribution structures which are located within the layer composite, are at least partially pressed together. By way of this, these spring-elastic elements assume the function of elastic elements within the electrochemical arrangement and thus ensure a homogeneous distribution of the pressing pressure of the layers of the electrochemical arrangement, which remains guaranteed over the whole lifetime of the electrochemical arrangement, since also a subsidence of the components of the electrochemical arrangement is compensated by way these elastic distribution structures acting as spring-elastic elements. By way of this, one therefore alleviates a deficiency which often compromises the function of the fuel cell.

Apart from the function as a spring-elastic element, such a spring-elastic distribution structure additionally assumes the function of the uniform distribution of the media within the active surface of the electrochemical arrangement. In this manner, on account of the present grouping of characteristics, one avoids an additional design expense and thus the production is technically simplified.

Media in this context—and also in the entirety of this patent application—are reactants for the operation of the fuel cell as well as coolants or other fluids.

Advantageous embodiments of the invention are possible according to the dependent claims and are shortly explained by way of the following example of a fuel cell for the previously mentioned electrochemical arrangements.

One advantageous embodiment of the invention envisages the spring-elastic distribution structures being arranged in the layer composite of the fuel cell arrangement as a spatially structured layer within this composite. By way of this, not only is the manufacture of the distribution structures significantly simplified, since the spring-elastic “distribution” layer may be formed (shaped) from a single piece, but one also achieves the advantage that simultaneously the sealedness of the distribution structures prevents an uncontrolled leakage of the reactants towards the outer layers of the fuel cell arrangement, and at the same time the supply of the active surfaces of the fuel cell with the reactants is effected in a particularly uncomplicated manner.

The particular advantageousness of the effect of spring-elastic distribution structures comes particularly to the forefront when the layer composite is not only created by way of simple layering, but by surface pressing, since it is particularly in this context that a homogeneous pressure distribution within the active surface of the fuel cell arrangement (for avoiding a power reduction and for avoiding an increased internal resistance) as well as the uniform distribution of the pressing pressure between the sealing elements and the active surface of the fuel cell is determined by a pressing force acting from the outside, and thus a non-uniform pressure distribution is avoided.

This is particularly the case when this surface pressing is created by way of clamping elements, since these clamping elements introduce the force into the fuel cell arrangement in a pointwise manner and this pointwise force introduction is converted into a homogeneous pressing pressure in particular by the spring-elastic distribution structures.

If the fuel cell arrangement is advantageously designed such that the distribution structure runs from its entry to its exit in an uninterrupted manner, then a solution which has a particularly low design effort results, wherein several distribution structures may also form a complete distribution plane.

The invention is hereinafter explained by way of a individual sketches.

There are shown in:

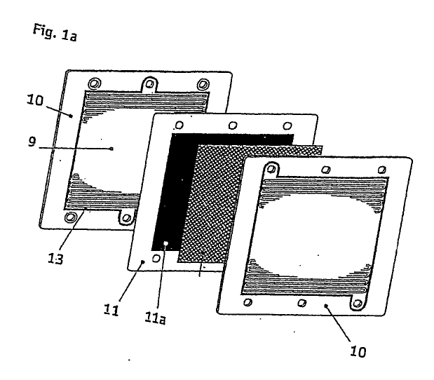

FIG. 1a a fuel cell arrangement in an exploded representation,

FIG. 1b the fuel cell arrangement shown in FIG. 1a, in the assembled condition,

FIG. 1c a fuel cell stack of a multitude of fuel cell arrangements which are layered on one another, as shown in FIG. 1b,

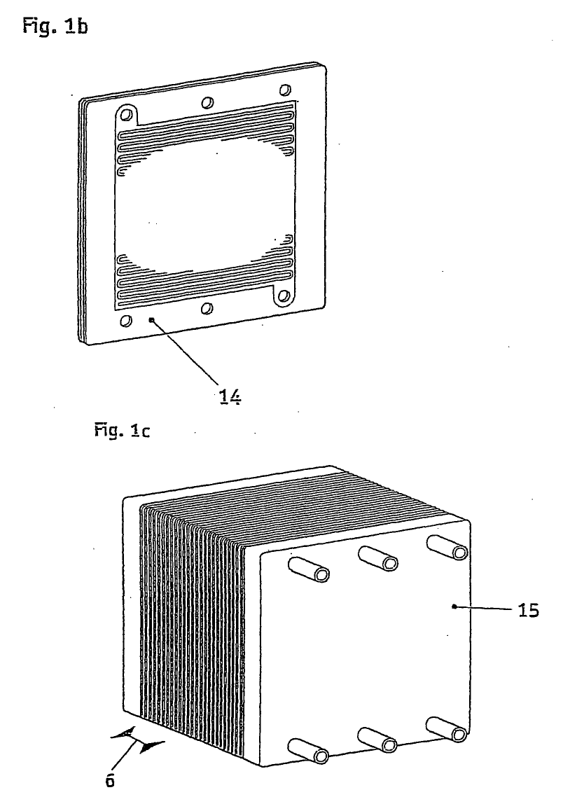

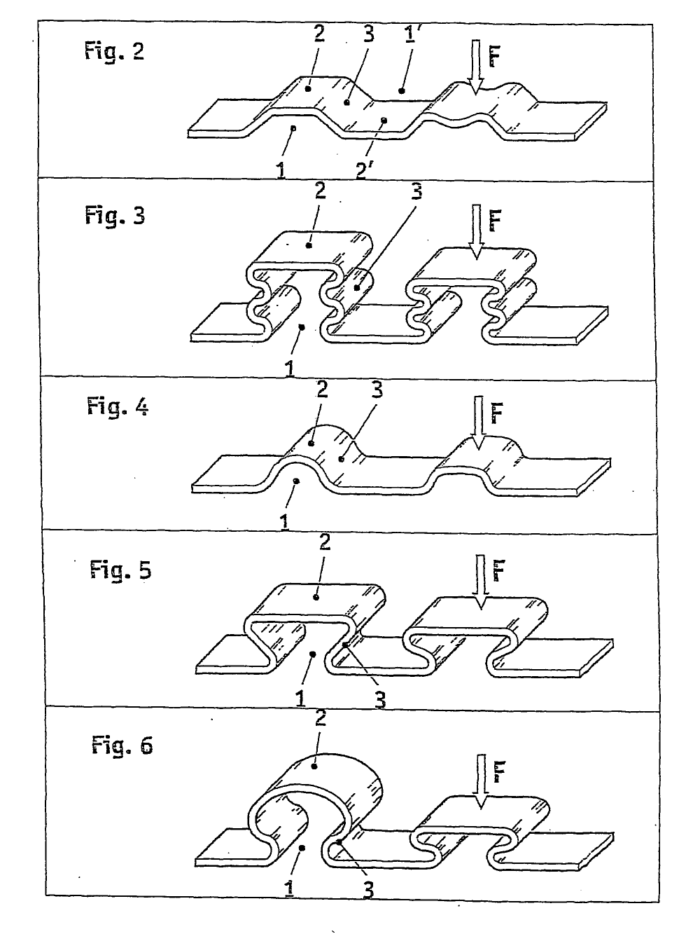

FIG. 2 one embodiment example for a flexible reactant distribution structure designed as a structured layer, in a spatial cross-section,

FIGS. 3 to 7 variations of spring-elastic distribution structures designed as a structured layer,

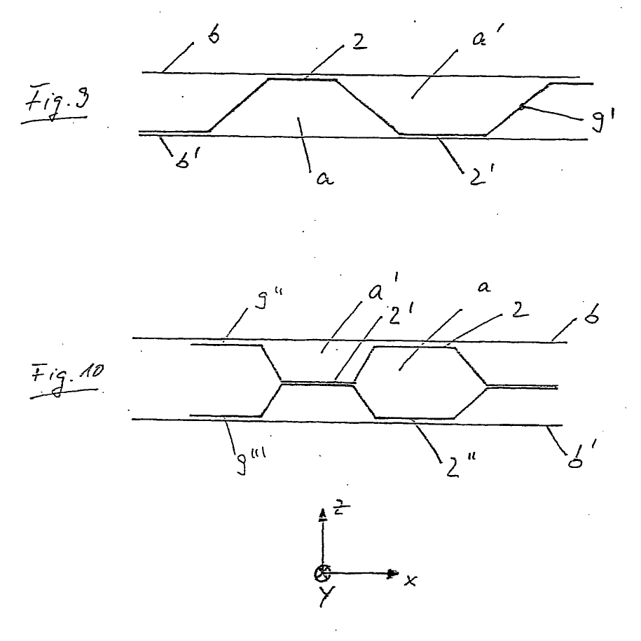

FIG. 8 the schematic serpentine course of a distribution structure as a design example, along the plane of the layer composite,

FIGS. 9+10 examples of layers according to the invention, as cooling layer or bipolar plate,

FIG. 11 a diagram of the spring rate.

The representation of the fuel cell arrangement 14, as well as the subsequent explanations of the embodiment example, serves as a representative example for all initially described electrochemical arrangements, such as also electrolysers or electrochemical compressors.

FIG. 1a shows the construction of a fuel cell arrangement 14 as is shown in FIG. 1b. A multitude of fuel cell arrangements 14 in a layered manner forms the region of a fuel cell stack 15 arranged between end plates in FIG. 1c. This is held together with a surface pressing by clamping elements, for example by way of claiming bolts or clamping belts.

A fuel cell 11 with its regular components is to be seen in FIG. 1a, which comprises a polymer membrane capable of conducting ions, which in the middle region 11a is provided with a catalyser layer on both sides. Furthermore two bipolar plates 10 are provided in the fuel cell arrangement 14, between which the fuel cell 11 is arranged. According to the present invention, spring-elastic channels 9 for incorporating and distributing reactants into the active surface 11a of the fuel cell 11 are represented in each bipolar plate of the fuel cell, and this active surface is represented schematically as a black surface 11a. In the assembled condition of the fuel cell arrangement 14, the electrochemically active region of the fuel cells is arranged in an essentially closed space which laterally of sealing elements 13 is essentially peripherally limited.

The schematically represented distribution structure 9 which here represents the spring-elastic distribution structures as an embodiment of the invention, may be designed as a structured layer, whose cross section is represented in the FIGS. 2 to 7 and which according to FIG. 8 forms a channel of a serpentine-like course along the plate 10 (thus perpendicular to the stack direction 6) of the fuel cell composite 14. The distribution structures may thereby be designed as individual channels which as a meander, open up the plane of the active surface, as well as two or multiple channels running in a meandering manner. Furthermore, the distribution structures may be designed as punchings or postlets which open up the plane of the active surface, or as a channel-like structure connects the entry and the exit in a suitable manner directly, or to one or more branches.

The materials of the distribution structure may in part also be of less elastic materials such as certain metals (e.g. aluminium, titanium) or also electrically conductive plastic, porous and electrically conductive non-wovens or fabrics, as well as electrically conductive ceramics. In these cases, the required elasticity originates from an elastic cooling plate.

In this context, FIG. 2 shows a spatially represented cross section through a spring-elastic distribution structure 1 which has an essentially trapezoidal cross section and is contained on one side by an end-face 2 (thus a surface parallel to the plane of the course of the distribution structure) and side walls 3. In this manner, the escape of the reactant in the direction of the end-face 2 parallel to the plane, and the side walls 3 is prevented, and the transfer over into the active region 11a at the side which is not contained is rendered possible.

Thereby, alternatively or simultaneously, one may also use the complementary intermediate space 1′ as a distribution structure for the transport of a medium. Then the surface 2′ along the plane of the base surface of the structured layer forms the complementary “end-wall” 2′.

This embodiment is thus in particular provided for the use as a spatially structured layer in a layer composite of a fuel cell arrangement, as is represented in the FIGS. 1a and 1b.

If then a pressure loading F is effected perpendicular to the plane of the structured layer, then in the example shown in FIG. 2, in particular the end-face 2 is pressed together in an arched manner and the edgings in the transition between the end-face 2 and the side wall 3 are brought into a rounded shape, by which means the material may give space to the pressure loading in a spring-elastic manner. In this embodiment therefore, the end-face 2 as well as the side wall 3 are deformed in a spring-elastic manner on exerting a perpendicular pressure loading.

In the previously described as well as all other forms of the structuring, the elasticity may be realised in that the material thickness of the, for example metallic, plate, from which the distribution structure is shaped (formed), is partially tapered such that a local stiffening may be set by way of cold deformation.

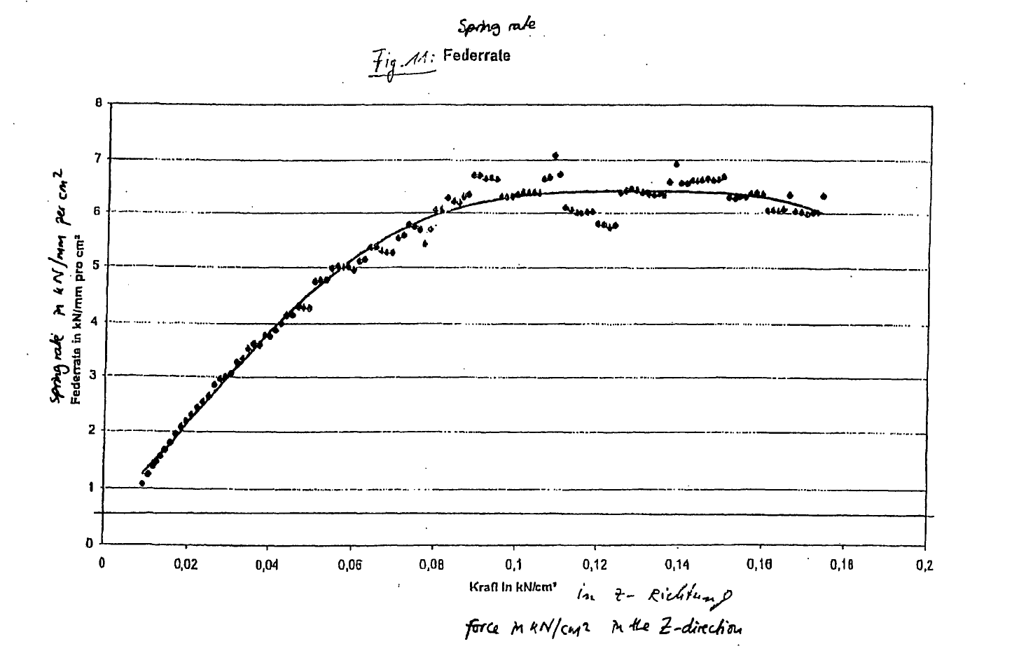

The elasticity of the distribution structure, depending on the case of application, must be capable of functioning in the region of 0.1 to 150 N/mm² surface pressing (preferably 0.5-10 N/mm² depending on the case of application). The materials used thereby have a modulus of elasticity of 10 to 250 kN/mm². The spring rate which is required with this is between 0.1 and 100 kN/mm per square centimetre, preferably between 0.2 and 100 kN/mm per cm², and particularly preferably between 0,5 and 50 kN/mm per cm². Here the surface pressing is effected by deploying force in the z-direction (see FIG. 10) and the surface specified in cm² defines the pressed surface in the x-y plane (see for example end-face 2, 2′ in FIG. 9 or 10), see also FIG. 11. FIG. 11 shows the defined course for a controlled electric bipolar plate, i.e. the degressive course of the spring rate over the surface pressing of a metallic bipolar plate as shown in FIG. 9 or 10, wherein a unitary spring rate was set over the x-y plane.

FIG. 3 in contrast shows (in an overdrawn representation for an improved illustration) one embodiment with which the layer 2, 3 forming the distribution structure is spatially structured such that with a perpendicular pressure loading, such as by way of the surface pressing in the layer composite of a fuel cell arrangement 15, as is created by clamping elements, essentially only the side walls 3 are deformed in the spring-elastic manner of an accordion, whilst the planar-parallel end-face 2 remains essentially undeformed. This is achieved by way of a serpentine preshaping of the side walls 3 which is ideally axially symmetrical to the perpendiculars of the cross section of the distribution structure 1.

FIG. 4 shows a further structurisation form with which once again with a perpendicular pressure loading F, the end-face 2 as well as the side wall 3 is deformed. The prestructuring here envisages a parabolic or Gaussian-bell-shaped cross section. Accordingly, with a pressure loading, the “maximal region” of the Gaussian bell is accordingly flattened, by which means the side walls 3 ascend or descend in a steeper manner.

FIG. 5 shows a further embodiment with which essentially the side walls 3 deform in a spring-elastic manner with a pressure loading, whilst the end-face 2 remains essentially unchanged. This is rendered possible by way of a trapezoidal-like structurisation of the spatially structured layer forming the distribution structure, wherein in contrast to that shown in FIG. 2 however, the longer parallel side forms the end-face 2 whilst the shorter, imagined parallel side of the trapezoidal-like structure runs along the plane of the base surface of the structurised layer. The angles which are enclosed by the sides of the trapezium and the parallel sides reduces with a pressure loading F.

A modification to this is represented in FIG. 6. Here, the edge transitions between the end-face 2, side walls 3 and the base surface of the structurised layer are designed in a round manner so that an “omega-shaped” cross section arises.

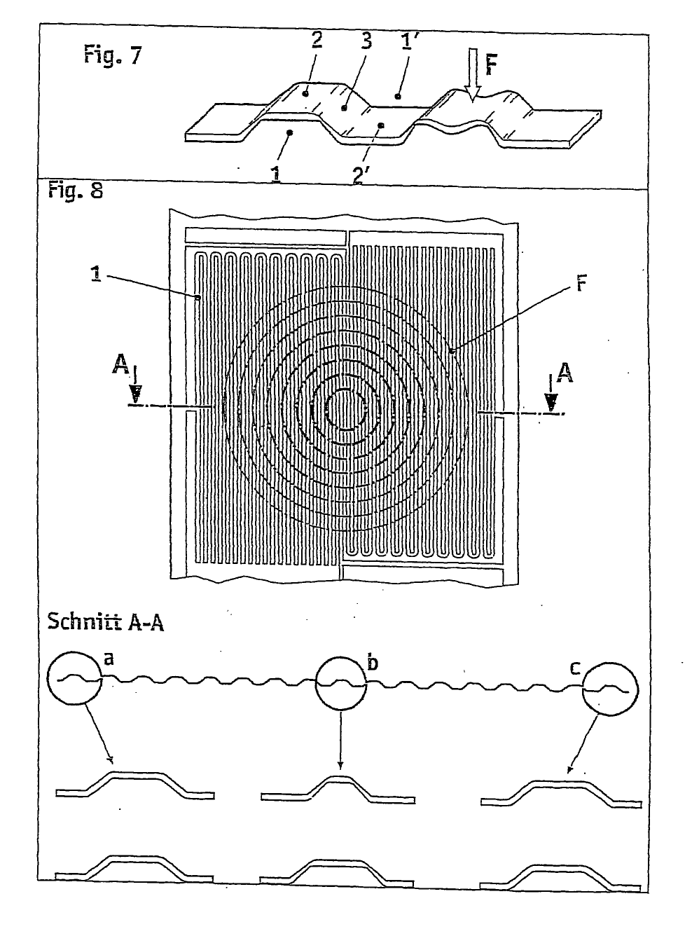

FIG. 7 shows a modified embodiment of that which is shown in FIG. 2. Here by way of a suitable control of the shaping procedure, one effects the material thickness being changed in the flanks or radii of the structure, such that the elasticity or the hardness of the material may be set in a targetted manner. The change of the material properties may be effected continuously or partially across the cross section (transverse to the structure) or along the distribution structure. Thus, a matching of the elasticity behaviour or the stiffness behaviour may be realised over the complete distribution structure.

FIG. 8 shows the serpentine course of the distribution structure 1 along the plane of the structurised layer which is not shown in more detail. The concentric circles F illustrate the course of the pressing force introduced in a pointwise manner, as they are introduced by clamping elements into the layer composite of the fuel cell arrangement 14. Thus by way of these “level lines”, one represents how, as a result of the pressure forces distributed in a spatially different manner, the distribution structure is pressed together to a differing extent, and on account of its spring-elastic properties, one achieves a spatially homogeneous distribution of the pressing pressure in the layer composite of the fuel cell arrangement 14. Thus the concentric circles for example enclose surfaces which have a different elasticity or stiffness by way of the structures described according to FIGS. 3 to 7. Therefore, the elasticity may be matched to the mechanical parameters of the fuel cell stack. Section A-A shows a outwardly reducing stiffness (region b has a higher stiffness compared to regions a and c).

Along the plane of the course of the distribution structure, hereby, the distribution structure may be given a partially different elasticity (realised by way of incorporating the structures represented for example in section A-A in FIG. 8) which is ideally adapted such that the elasticity in the regions with a lower surface pressing of the fuel cell plane is increased.

Thus, on the one hand, one may achieve a good electrical contact from bipolar plate to bipolar plate, and on the other hand the uniform distribution of the media, such as hydrogen and air as reactants, or also a cooling medium. The improved electrical contact on account of the homogeneous pressure distribution leads to an increase in power of the fuel cell. By way of a suitable design, it is rendered possible to distribute bracing forces onto sealing functions and onto active cell regions in a targeted manner, so that it is ensured that once the surface pressing has been set, it is maintained and remains homogeneous over the lifetime.

Apart from fuel cell stack arrangements, with which the bipolar plates and thus the distribution structures consist of metal, the elastic distribution structure may be arranged in layers at various locations in a fuel cell stack which consists of graphite, graphite-filled plastics or conductive plastics. This distribution structure which as a result is formed using graphite, graphite-filled plastics or conductive plastics of the same type may in this case preferably be used as a metallic cooling distribution structure.

Apart from the application to fuel cells, the distribution structure described here may also be used advantageously for electrolysers or electrochemically compressors which relate to the same type.

Table 1 gives an overview as to how, by way of the application of distribution structures according to the invention, mainly for the transport of a cooling medium, the inner resistance R of the cooling layer of the fuel cell could be decisively reduced.

Thus table 1 shows comparative values for the fuel cell arrangement, wherein the voltage differences are specified across the individual cooling layers or cells. With regard to these cooling layers, it is the case for example of cooling layers as are indicated in FIG. 9. Here it may be clearly seen that with the bipolar plate with an elastic behaviour, the voltage drop over the cooling layer is significantly lower than with a standard cell construction, so that an increase of the useful voltage of 5 to 10% may be realised without further ado.

Accordingly, the values specified in Table 1 for a fuel cell arrangement designed according to the invention and a fuel cell arrangement, with which bipolar plates are applied on one another in a stiff manner in the cooling region, are represented graphically by comparison in diagram 1.

FIG. 9 shows a distribution structure according to the invention, which is designed as a fluid-tight plate 9′.

“Plate” here is preferably to be understood as a plate which is shaped is a single-layered manner. These may for example be plates of a sheet-metal, into which a suitable structure with channels or different types of projections may be embossed. Even if this layer is indicated as being “single-layered”, it may for example be coated. What is essential, is the fact that here it is not the case for example of a plate bent for example in the shape of an accordion with overlapping sections, which in the z-direction (see coordinate system below FIG. 10) would then have a large extension. The plate shown in FIG. 9 here is designed as a cooling layer which with its end-faces 2 and 2′ borders on bordering elements b and b′ respectively. With regard to the plate 9′, it may for example be the case of a simply held bipolar plate which comprises spaces a, a′ which are complementary and mutually media-tight. These complementary spaces are preferably at least partly arranged next to one another in the x-y plane (thus perpendicular to the direction of the layering of the electrochemical arrangement). However also at 9′, it may also be the case of a cooling layer which for example is located in the inside of a “composite” bipolar plate whose outer layers are in each case stiff (for example on account of graphite or ceramic constituents), so that the deformability is ensured by the cooling layer.

A further example of a bipolar plate is given in FIG. 10. This bipolar plate again with the end-faces 2 and 2″ borders adjacent elements b and b′ respectively. Here the bipolar plate is constructed of two plates, specifically the plates 9″ and 9′″. Here in total there are three media spaces a, a′, a″ separated from one another.

With the previously mentioned distribution structures or plates, it is essential for these on the one hand to be designed in a media-tight manner and furthermore to be elastically deformable in the z-direction, thus elastically deformable in the direction of the layering of the electrochemical arrangement. Here, the plates or structures preferably have a spring rate between 0.5 and 50 kN/mm per cm².

The bipolar plates are of metal, preferably aluminium, titanium, steel and/or their alloys, particularly preferably of stainless steel, e.g. 1.4404, 1.4401, 1.4539 and have a material thickness of 0.02 mm to 5 mm, preferably 0.03 mm to 2 mm, particularly preferably from 0.05 mm to 0.5 mm, most preferably from 0.05 to 0.3 mm. Here, it is particularly advantageous, as shown for example in FIGS. 9 and 10, that the plates “by themselves” create an elastic compensation of an electrochemical arrangement and additionally are suitable for separating various media (cooling media or reaction media). Here it is particularly advantageous, as is to be seen for example in FIGS. 9 and 10, that a varying spring stiffness may be given perpendicular to the direction of the layering (z-direction) in the X-Y plane, in order thus to achieve a uniform pressing pressure over the whole surface of the plane b and b′ respectively.

The main advantage of the invention lies in the fact that with the distribution structures/plates according to the invention for example, one may achieve a defined elasticity which due to the adapted pressing increases the total efficiency of the arrangement, and furthermore a gas separation and also a uniform gas distribution is ensured by way of these structures or plates.

[image]

TABLE 1
Standardzellaulbau
Spannung bel 500 mA/cm²

| | Kühllage 1 | Zelle 1 | Kühllage 2 | Zelle 2 | Kühllage 3 | Zelle 3 | Kühllage 4 | Gesamt |
|---|---|---|---|---|---|---|---|---|
| U in mV | −15.7 | 622.0 | −90.6 | 590.0 | −97.0 | 604.0 | −86.0 | 1526.8 |
| R in mOhm*cm² | 31.3 | 1244.0 | 181.2 | 1180.0 | 194.0 | 1208.0 | 172.0 | 3053.5 |

Bipolarplatte mit elastischem Verhalten
Spannung bel 500 mA/cm²

| | Kühllage 1 | Zelle 1 | Kühllage 2 | Zelle 2 | Kühllage 3 | Zelle 3 | Kühllage 4 | Gesamt |
|---|---|---|---|---|---|---|---|---|
| U in mV | −6.8 | 532.0 | −0.3 | 548.0 | −0.6 | 567.0 | −11.9 | 1827.5 |
| R in mOhm*cm² | 13.6 | 1064.0 | 0.5 | 1096.0 | 1.2 | 1134.0 | 23.8 | 3254.9 |

What is claimed is:

1-21. (canceled)

22. A fuel cell comprising:
at least one plate having a distribution portion for distributing a medium;
at least one distribution structure being disposed within said distribution portion;
whereby said distribution structure is elastic in at least one plane between a loaded condition and an unloaded condition.

23. The fuel cell of claim 1, wherein said distribution structure is disposed between at least two plates on a spatially structured layer.

24. The fuel cell of claim 1, wherein said distribution structure is formed by a surface pressing.

25. The fuel cell of claim 1, wherein said fuel cell includes a plurality of plates secured together by surface pressing.

26. The fuel cell of claim 1, wherein said fuel cell includes a plurality of plates secured together by clamping.

27. The fuel cell of claim 1, including a first plate in sealing communication with a second plate, wherein said distribution structure is disposed between said first plate and said second plate.

28. The fuel cell of claim 1, wherein said distribution structure provides an uninterrupted entry and exit for said media.

29. The fuel cell of claim 1, wherein said distribution structure includes a generally trapezoidal cross-section in said unloaded condition.

30. The fuel cell of claim 1, wherein said distribution structure includes a generally parabolic cross-section in said unloaded condition.

31. The fuel cell of claim 1, wherein said distribution structure includes a generally omega-shaped cross-section in said unloaded condition.

32. The fuel cell of claim 1, wherein said distribution structure is generally elastically deformed in said loaded condition.

33. The filet cell of claim 1, wherein said distribution structure includes generally deformed sidewalls in said loaded condition.

34. The fuel cell of claim 1, wherein said distribution structure includes discrete projections extending outwardly from said distribution portion.

35. The fuel cell of claim 1, wherein said distribution structure includes a channel.

36. The fuel cell of claim 1, wherein said distribution structure includes partial tapering of a material thickness.

37. The fuel cell of claim 1, wherein said distribution structure includes a plurality of partially different elastic portions.

38. The filet cell of claim 1, wherein said distribution structure is formed from at least one of a graphite, a graphite-filled plastic, and a conductive plastic.

39. The fuel cell of claim 1, wherein said distribution structure includes a media-tight plate.

40. The fuel cell of claim 1, wherein said distribution structure spring rate is between 0.5 kN/mm per cm² and 50 kN/mm per cm².

41. The fuel cell of claim 1, wherein said distribution structure includes a first portion having a first space proximate a second portion having a second space, said first portion and said second portion sharing at least one wall.

42. The fuel cell of claim 1, wherein said distribution structure includes a first space having a first opening in a first direction and a second space having an opening in a second direction, said first space being proximate said second space and said first direction being opposite said second direction.

43. The fuel cell of claim 1, wherein said plate is at least one of a cooling plate and a bipolar plate.

44. The fuel cell of claims 1, wherein said fuel cell is an electrolyser system or an electrochemical compressor system.
